(19) United States
(12) Patent Application Publication
(10) Pub. No.: US 2023/0162395 A1
(43) Pub. Date: May 25, 2023

(54) Point-Cloud Processing

(71) Applicant: Blickfeld GmbH, München (DE)

(72) Inventors: Hamidreza Houshiar, München (DE); Rolf Wojtech, München (DE)

(21) Appl. No.: 17/920,223

(22) PCT Filed: Jun. 7, 2021
(86) PCT No.: PCT/EP2021/065129

§ 371 Date: Oct. 20, 2022

(30) Foreign Application Priority Data
Jun. 8, 2020 (DE) 10 2020 115 145.4

(51) Int. Cl. G06T 7/73; G01S 17/89

(52) U.S. Cl. CPC G06T 7/75; G01S 17/89; G06T 2207/10028

(57) ABSTRACT

A processing circuitry of a LIDAR measurement device (101, 102, 103) in a multi-pose fixed-pose measurement setup is disclosed. The circuitry receives a plurality of data points of a point-cloud dataset, each data point of the plurality of data points indicating a respective depth position (601), different data points of the plurality of data points being associated with different lateral positions in a field-of-view (602) of the LIDAR measurement device (101, 102, 103), each lateral position being associated with a respective predefined reference depth threshold. For each data point of the plurality of data points, the circuitry performs a comparison of the depth position (601) indicated by the respective data point with the respective reference depth threshold and selectively discards the data point upon the respective comparison yielding that the depth position (601) indicated by the respective data point substantially equals the respective reference depth threshold. Upon said selectively discarding, the circuitry outputs, to an external interface of the LIDAR measurement device (101, 102, 103) connected to a communications link (108), the point-cloud dataset. Point-cloud datasets (191, 192, 193) can be provided to a server (109). The circuitry facilitates a size reduction of the point-cloud datasets by removing data points from a point-cloud dataset that are associated with a background of a scene which is static with respect to the LIDAR scanner. This facilitates reduced computational resources for subsequent applications. The circuitry also may determine malfunction of the measurement device.

### TECHNICAL FIELD

Various examples relate to processing of point-clouds provided by light detection and ranging (LIDAR) measurements. Various examples specifically relate to background subtraction.

### BACKGROUND

Using LIDAR scanners, a point-cloud dataset of a scene can be provided. The point-cloud dataset includes multiple data points. Different data points of the point-cloud dataset are associated with different lateral positions in the field-of-view of the LIDAR scanner. I.e., horizontal and/or vertical scanning is possible. Sometimes, the data points may include indicators indicative of the lateral position. The data points of the point-cloud dataset are indicative of respective depth positions. The depth position of a data point marks the distance of a respective object in the environment to the LIDAR scanner. This distance can be determined using ranging. The distance can be expressed in, e.g., meters.

It has been observed that point-cloud datasets can have a significant size. For instance, a given point-cloud dataset (sometimes also referred to as point-cloud frame) can include thousands or tens of thousands or even up to a million data points. Each data point can, in turn, include multiple bits, i.e., to implement an indicator indicative of the depth position and, optionally, the lateral position. Further, point-cloud datasets can be provided at a sampling rate of the LIDAR scanner and typical sampling rates are in the range of 5 Hz-10 KHz.

Accordingly, it has been found that computational resources required by applications operating based on point-cloud datasets can be demanding. For example, it has been observed that a transmission data rate of a communications link used to communicate point-cloud datasets from a LIDAR scanner to a server for processing can be high. Furthermore, object recognition to be implemented on point-cloud datasets can require significant processing power and memory, to be able to handle the point-cloud datasets.

### SUMMARY

Accordingly, there is a need for advanced techniques of processing point-cloud datasets. In particular, there is a need for processing point-cloud datasets in order to relax computational resource requirements for applications operating based on the point-cloud datasets.

This need is met by the features of the independent claims. The features of the dependent claims define embodiments.

Techniques are described that facilitate processing of point-cloud datasets. The techniques described herein facilitate a size reduction of the point-cloud datasets. In particular, data points of low or limited information content can be discarded.

For example, according to some techniques described herein, it is possible to remove/discard data points from a point-cloud dataset that are associated with a background of a scene.

Generally speaking, the background of a scene describes a set of objects of the scene that are static with respect to the LIDAR scanner.

By discarding data points associated with the background of the scene, the overall size of the point-cloud dataset can be reduced. This facilitates reduced computational resources for subsequent applications that operate based on the point-cloud dataset having a reduced count of data points. A transmission data rate of a communications link used to communicate the point-cloud datasets can be reduced.

A method includes receiving, by a processing circuit of a LIDAR measurement device, a plurality of data points of a point-cloud dataset. Each data point of the plurality of data points of the point-cloud dataset indicates a respective depth position. Different data points of the plurality of data points of the point-cloud dataset are associated with different lateral positions in a field-of-view of the LIDAR measurement device. Each lateral position is associated with a respective predefined reference depth threshold. The method also includes a processing circuit of the LIDAR measurement device performing, for each data point of the plurality of data points of the point-cloud dataset, a respective comparison. The respective comparison is between the depth position indicated by the respective data point and the respective reference depth threshold. The method also includes, for each data point of the plurality of data points and at the processing circuitry of the LIDAR measurement device, selectively discarding the respective data point upon the respective comparison yielding that the depth position indicated by the respective data point substantially equals the respective reference depth threshold. The method also includes, upon said selectively discarding, outputting, by the processing circuitry, to an external interface of the LIDAR measurement device connected to a communications link, the point-cloud dataset.

A computer program or a computer-program product or a computer readable storage medium includes program code that can be loaded and executed by at least one processor of a LIDAR measurement device. Upon loading and executing such program code, the at least one processor performs a method. The method includes receiving, by a processing circuit of a LIDAR measurement device, a plurality of data points of a point-cloud dataset. Each data point of the plurality of data points of the point-cloud dataset indicates a respective depth position. Different data points of the plurality of data points of the point-cloud dataset are associated with different lateral positions in a field-of-view of the LIDAR measurement device. Each lateral position is associated with a respective predefined reference depth threshold. The method also includes a processing circuit of the LIDAR measurement device performing, for each data point of the plurality of data points of the point-cloud dataset, a respective comparison. The respective comparison is between the depth position indicated by the respective data point and the respective reference depth threshold. The method also includes, for each data point of the plurality of data points and at the processing circuitry of the LIDAR measurement device, selectively discarding the respective data point upon the respective comparison yielding that the depth position indicated by the respective data point substantially equals the respective reference depth threshold. The method also includes, upon said selectively discarding, outputting, by the processing circuitry, to an external interface of the LIDAR measurement device connected to a communications link, the point-cloud dataset.

A method includes receiving one or more point-cloud datasets at a server. The one or more point-cloud datasets are received from one or more LIDAR measurement devices and via one or more communications links. The method also includes performing an object detection at the server based on the one or more point-cloud datasets.

It would be possible that a least one of the one or more point-cloud dataset comprises a placeholder data structure indicative of a non-defined depth position in the respective point-cloud dataset. The object detection can operate based on the placeholder data structure. For example, the object detection could determine a likelihood of presence of a low-reflectivity object based on the placeholder data structure included in the point-cloud dataset.

A method includes receiving a plurality of data points of a point-cloud dataset at a processing circuitry of a LIDAR measurement device. Each data point of the plurality of data points of the point-cloud datasets indicates the respective depth position. Different data points of the plurality of data points of the point-cloud dataset are associated with different lateral positions in a field-of-view of the LIDAR measurement device. Each lateral position is associated with a respective predefined reference depth threshold. The method also includes, at the processing circuitry of the LIDAR measurement device and for each data point of the plurality of data points of the point-cloud dataset: performing a respective comparison of the depth position indicated by the respective data point with a respective reference depth threshold. The method further comprises, in response to detecting that the respective comparisons of a predefined count of the data points of the plurality of data points yield that the depth positions indicated by these data points do not substantially equal the respective reference depth threshold, triggering a fault mode of the LIDAR measurement device.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a system including multiple LIDAR measurement devices imaging a scene from different perspectives, as well as a server according to various examples.

FIG. 2 schematically illustrates details with respect to the server according to various examples.

FIG. 3 schematically illustrates details with respect to the LIDAR measurement devices according to various examples.

FIG. 4 is a flowchart of a method according to various examples.

FIG. 5 schematically illustrates a time sequence of point-cloud datasets acquired by a LIDAR measurement device according to various examples.

FIG. 6 schematically illustrates a histogram of depth values of a data point of the point-cloud datasets of the sequence according to various examples.

FIG. 7 is a 2-D spatial plot of the depth and lateral positions indicated by data points of the point-cloud dataset and, furthermore, illustrates reference depth thresholds according to various examples.

FIG. 8 schematically illustrates the point-cloud dataset of FIG. 7 after discarding data points according to various examples.

FIG. 9 schematically illustrates a point-cloud dataset triggering a fault mode according to various examples.

FIG. 10 schematically illustrates a multi-perspective object detection operating based on multiple LIDAR point-cloud datasets according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of processing a point-cloud dataset are described. The point-cloud dataset can be acquired based on LIDAR measurements or other kinds and types of measurements such as other time-of-flight or ranging measurements, e.g., radar, or, e.g., stereoscopic measurements. The point-cloud dataset includes multiple data points and each data point is associated with a respective lateral position within a field-of-view of the measurement device, e.g., a LIDAR scanner. As a general rule, the lateral position defines the horizontal and vertical position, i.e., perpendicular to the z-axis along which the depth position is determined.

For instance, the point-could dataset include an indicator indicative of lateral and/or vertical position within the field-of-view of the respective data point. For instance, in the case of a LIDAR measurement, the LIDAR scanner can include a beam steering unit that is configured to deflect primary light that is emitted into the environment by a certain angle; then, the position of the beam deflection unit can be associated with the respective lateral position indicated by the data point of the point-cloud dataset. It would also be possible to rely on flash LIDAR: Here, light is emitted into multiple directions and a separation of the lateral position is made in the receive path, e.g., by focusing returning secondary light reflected at objects at different lateral positions onto different detector elements.

Hereinafter, for sake of simplicity, various techniques will be described in connection with LIDAR measurements. However, similar techniques may also be readily applied to other kinds and types of ranging measurements

Various techniques described herein can be applied to fixed-pose LIDAR measurements. Here, the pose (position and perspective) of the LIDAR measurement device (or any other type of measurement device configured to provide the point-cloud dataset) is fixed with respect to the scene. I.e., there is a static background, e.g., formed by one or more background objects such as walls, permanent obstacles, ground, vegetation, etc. that is similarly imaged by point-cloud datasets subsequently sampled. Such a fixed-pose LIDAR measurement can be distinguished against a variable-pose LIDAR measurement: In latter case, a mobile LIDAR measurement device is used that, over the course of time, change its pose with respect to the scene. Typical use cases would be automotive-mounted LIDAR measurement devices or backpacks equipped with a LIDAR measurement device for cartography.

Various techniques are based on the finding that for fixed-pose LIDAR measurements, a background subtraction is feasible. In particular, various techniques are based on the finding that the background should be similarly represented in subsequently sampled point-cloud datasets. Then, from a change of the depth positions of the data points of subsequently sampled point-cloud datasets, the background can be detected.

Various techniques described herein can find application in a multi-pose fixed-pose LIDAR measurement setup. Here, multiple LIDAR measurement devices are deployed at different poses with respect to the scene so that multiple point-cloud datasets sampled at a given time instance provide different perspectives on objects in the scene. This can be helpful, e.g., for applications such as object detection or object recognition, because more information regarding an object in the scene can be available based on the multiple perspectives. Partial obstructions can be circumvented by redundancy in the poses. Thereby, these applications can be implemented more robust and can benefit from additional level of detail included in the multiple point-cloud datasets.

According to various examples, processing of point-cloud datasets can be executed in a decentralized manner. I.e., processing of the point-cloud datasets can be executed at processing circuitry of LIDAR measurement devices, prior to transmitting the point-cloud datasets to a central server via a respective communications link. The processing circuitry can be integrated into the same housing also including sensor circuitry for performing the LIDAR measurements, e.g., a laser and a detector. The processing can be performed in a decentralized manner at individual LIDAR measurement devices that have varying perspectives onto the scene, i.e., prior to fusing the point-cloud datasets into an aggregate multi-pose point-cloud dataset. Such an approach reduces the required data rate on the communications link.

In particular, it would be possible that data points of a point-cloud dataset associated with the background of the scene are discarded. Discarding a data point can mean that the respective data point data structure is removed—i.e., permanently deleted—from the point-cloud dataset, so that the point-cloud dataset is reduced in size by the amount corresponding to the respective data point. For example, it would be conceivable that the point-cloud dataset is in array form, wherein each row of the array indicates a respective data point data structure. For instance, prior to the processing of the point-cloud dataset, the array may have a number of N entries. Then, a count of M, smaller or equal to N, data points are detected to correspond to the background and it is then possible that the corresponding output point-cloud dataset that is obtained based on the input point-cloud dataset upon discarding the data points corresponding to background is an array having N−entries.

Further, techniques will be described that implement processing of the point-cloud dataset on a data-point hierarchy level. I.e., it is possible that background subtraction is implemented individually for each data point of the point-cloud dataset. This is, in particular, in contrast to techniques which require background detection implemented based on an ensemble of data points of the point-cloud dataset and/or by considering a temporal evolution of the various data points of the point-cloud dataset. In the techniques described herein, it is possible to judge, for each data point of the point-cloud dataset, whether the corresponding depth position is behind or in front of a respective reference depth threshold—defined per data point; i.e., different data points are associated with different respective reference depth thresholds—and then to selectively discard the data point upon finding that the depth value is at or behind the reference depth threshold. This is based on the finding that, for each individual data point, it can be judged whether the individual data point currently measures a background object or a foreground object based on its associated depth position relating to the reference depth threshold, wherein the reference depth threshold is determined to be at a position resembling the background. Then, if the respective depth position of the data point is between the reference depth threshold and the LIDAR measurement device, it can be judged that the depth position is associated with a foreground object; otherwise, the depth position is associated with background. Such an approach is particularly easy to implement and requires limited computational resources (due to the individual processing on the data point hierarchy level); and, thus, can be implemented at the processing circuitry deployed at the LIDAR measurement device.

Alternatively or additionally to such discarding of data points based on the reference depth threshold, the reference depth threshold could be used to identify a fault mode of the LIDAR measurement device. In particular, in a scenario in which for a significant count of lateral positions the depth position deviate from the reference depth thresholds, it can be judged that the fault mode is encountered. The fault mode can be associated with one or more malfunctioning components of the LIDAR measurement device. As one or more components malfunction, the depth position detected by the LIDAR measurement is likely to deviate from the reference depth threshold. On the other hand, the scene is unlikely to change so significantly that the background changes instantaneously for the significant count of lateral positions. Accordingly, such changes in the point cloud datasets in which multiple of the lateral positions deviate from the reference depth threshold can be a strong evidence of malfunctioning. Such detection of the malfunctioning has the advantage that a large number of components of the LIDAR measurement device are monitored: for the LIDAR measurement to be uncorrupted, typically all components in the measurement chain need to operate correctly, including control electronics or lasers and beam steering units, lasers, transmit optics, receive optics, control electronics for detectors, signal processing of outputs of the detectors, analog-digital conversion, low-level point cloud dataset processing, etc. Thus, overall functional safety can be ensured.

As a general rule, the reference depth threshold could take a finite value or remain undefined, e.g., set to infinity (as would be the case if the background of the scene is beyond the measurement range of the LIDAR measurement).

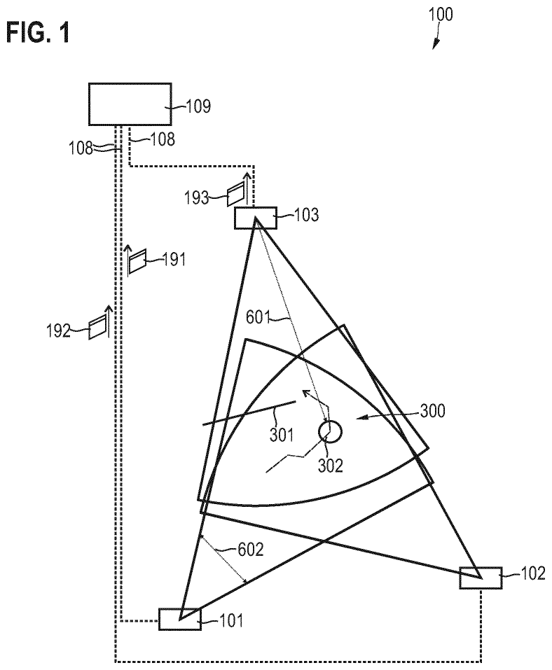

FIG. 1 schematically illustrates aspects with respect to a system 100. The system 100 includes multiple LIDAR measurement devices 101-103 and a central server 109. Communications links (illustrated by the dotted lines in FIG. 1) are established between the LIDAR measurement devices 101-103 and the server 109. For instance, point-cloud datasets 191-193 can be provided by each one of the LIDAR measurement devices 101-103 to the server 109.

The point-cloud datasets 191-193 can be associated with timestamps indicative of a point in time at which the respective point-cloud dataset has been sampled. The point-cloud datasets 191-193 all depict a scene 300; however, as the pose of the LIDAR measurement devices 101-103 with respect to the scene 300 varies, also the perspective of the point-cloud datasets 191-193 depicting the scene 300 varies. This means that, e.g., the depth position 601 and the lateral position within the field-of-view 602 (small dotted lines in FIG. 1, only illustrated as examples for the LIDAR measurement devices 101, 103) will vary between the point-cloud datasets 191-193.

As illustrated in FIG. 1, the scene 300 includes two objects 301,302. The object 301 is static over time, e.g., could be a wall or obstacle or lane marking on the road, etc. Thus, the lateral position and depth position of data points in the point-cloud datasets 191-193 associated with the object 301 is time invariant. Thus, the object 301 constitutes a background of the scene 300 and could be labelled background object 301. In contrast, the object 302 moves through the scene. Thus, the depth position 601 in the lateral position of the object 302 shows a time dependency. The object 302 can be seen in front of the background object 301. Thus, the object 302 forms part of the foreground and could be labelled foreground object 302.

According to the various examples described herein, it is possible to process the point-cloud datasets 191-193 at the LIDAR measurement devices 101-103, to discard data points associated with the background object 301, but to retain data point associated with the foreground data object 302.

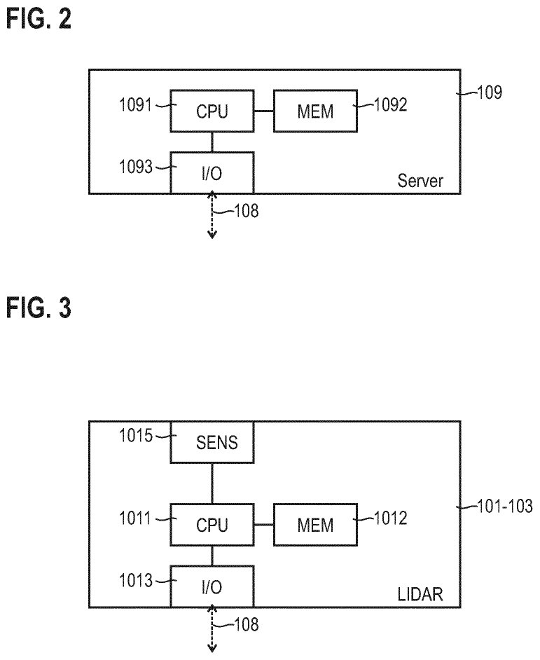

FIG. 2 schematically illustrates aspects with respect to the server 109. The server 109 includes a processing circuitry, e.g., implemented by one or more central processing units. The server also includes a memory 1092 that is accessible by the processing circuitry 1091, e.g., to load program code. The processing circuitry 1091 can also communicate via an interface 1093 with the LIDAR measurement devices 101-103, via the communications links 108. Upon loading program code from the memory 1092, the processing circuitry 1091 can execute the program code and, based on this execution, perform techniques as described herein, e.g.: performing a multi-pose object recognition based on the multiple point-cloud datasets 191-193; fusing the multiple point-cloud datasets 191-193 to obtain an aggregated point-cloud dataset of the scene 300; performing one or more applications based on the multiple point-cloud datasets 191-193 (LIDAR applications), e.g., including object detection/classification, simultaneous localization and mapping (SLAM), and/or control tasks. For example, one application may pertain to detecting objects in the scene 300 and then controlling movement of one or more vehicles through the scene 300. For instance, automated valet parking could be implemented.

FIG. 3 schematically illustrates aspects with respect to the LIDAR measurement devices 101-103. The LIDAR measurement devices 101-103 include sensor circuitry 1015 configured to perform the light-based ranging measurement in the field-of-view (FOV) 602, i.e., laterally resolved. For this, primary light can be emitted to the scene 300, e.g., in pulsed form or continuous wave. Secondary light reflected at the scene 300 can then be detected and ranging can be implemented. The LIDAR measurement devices 101-103 include a processing circuitry 1011, e.g., implemented by a microcontroller, a central processing unit, an application-specific integrated circuit, and/or a field-programmable gate array (FPGA). The processing circuitry 1011 is coupled to a memory 1012 and can, e.g., load and execute program code from the memory 1012. The processing circuitry 1011 can communicate via the communications link 108, by accessing an interface 1013. For instance, upon processing a respective point-cloud dataset 191-193, the processing circuitry 1011 can transmit the process point-cloud dataset 191-193 via the interface 1013 to the server 109, using the communications link 108. Upon loading and executing the program code from the memory 1012, the processing circuitry 1011 can be configured to perform one or more of the techniques described herein, e.g.: performing a background subtraction by detecting data points in the point-cloud dataset that are closer to the LIDAR measurement device 101-103 than a respective reference depth threshold; determining the reference depth threshold, e.g., by considering one or more reference point-cloud datasets; discarding data points from the respective point-cloud dataset; adding placeholder data structures to the respective point-cloud datasets; triggering a fault mode, e.g., based on a comparison of the depth positions of multiple data points with the respective reference depth positions and/or based on a further comparison of a reflectivity of multiple data points with respective reference reflectivities; etc.

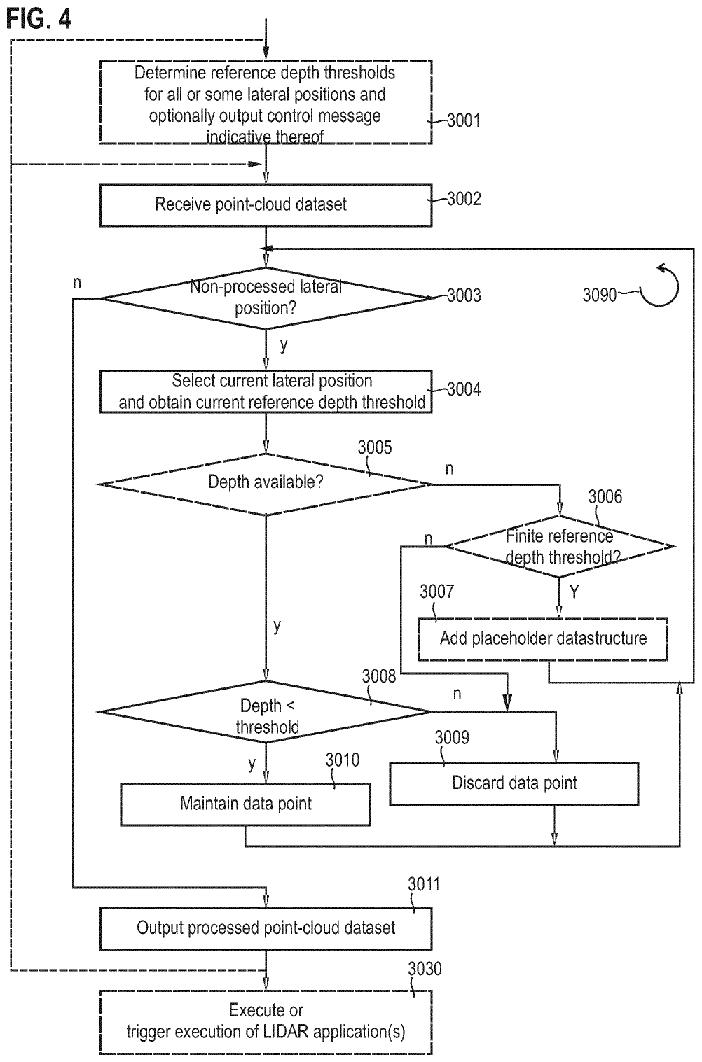

FIG. 4 is a flowchart of a method according to various examples. Optional boxes are illustrated using dashed lines in FIG. 4.

For instance, it would be possible that the method, at least in parts, is executed by a LIDAR measurement device, e.g., by the processing circuitry 1011 of the LIDAR measurement device 101, or any one of the further LIDAR measurement devices 102-103, upon loading program code from the memory 1012. In particular, it would be possible that boxes 3001-3011 are executed by the LIDAR measurement device and box 3030 could be executed by a server, e.g., by the processing circuitry 1091 of the server 109.

The method of FIG. 4 generally relates to point-cloud processing in a decentralized manner. The method of FIG. 4 facilitates reducing computational resources associated with one or more LIDAR applications that operate based on the process point-cloud dataset—if compared to a scenario in which the one or more applications would operate on the non-processed point-cloud dataset.

The method commences at box 3001: Here, reference depth thresholds are determined for all or at least some lateral positions within the field-of-view 602 of the LIDAR measurement device 101-103. For instance, the reference depth thresholds may be determined for each data point associated with a respective lateral position.

As a general rule, various options are available for determining the reference depth thresholds at box 3001. For example, it would be possible that, for each lateral position, a historic maximum depth position is determined and that the reference depth threshold associated with this lateral position is then determined based on this maximum value. I.e., it can be checked, for each lateral position, what maximum value is taken by the respective data point over the course of time and then it can be judged that this maximum value is associated with a background object of the background in the field-of-view. More specifically, such judgement can be made based on one or more reference point-cloud datasets. For instance, the one or more reference point-cloud datasets may be buffered at the respective LIDAR measurement device 101-103. It would be possible that a maximum value of the depth positions of each one of the plurality of data points (the data points are associated with the lateral positions in the field-of-view) is determined across the one or more reference point-cloud datasets and then the reference depth threshold is determined based on this maximum value. Here, as a general rule, it may not be required to retain all these reference datasets in the buffer for a significant time duration; rather, for each newly acquired point-cloud dataset, it would be possible to make a comparison of the depth position with the currently stored reference depth threshold (representing the maximum value of the depth position of the respective data point across all reference point-cloud datasets that have been acquired so far) and, if this comparison yields that the depth position of the data point in the currently acquired point-cloud dataset has a larger distance to the LIDAR measurement device 101-103 if compared to the reference depth threshold, then the reference depth threshold can be adjusted in accordance with the depth position of the data point in the currently acquired point-cloud dataset. Thereby, it is only required to retain the reference depth thresholds for all lateral positions in the memory. This corresponds to a continuously progressive adjustment of the reference depth threshold, as new point-cloud datasets are acquired and become available to the processing circuitry of the LIDAR measurement device 101-103. In such a continuously progressive scenario, it is not required to retain a significant number of historical values of the depth position of the respective data point in the memory of the LIDAR measurement device.

As a general rule, alternatively or additionally to this comparison based on depths positions, it would be possible to consider other measured quantities of the LIDAR measurement device. Examples include: velocity (e.g., as obtained from heterodyne-type detection) with a respective reference velocity threshold, and reflectivity (e.g., as obtained from considering the signal amplitude) with a respective reference reflectivity threshold. Hereinafter, for sake of simplicity, example techniques are described with respect to a depth-position-based comparison, but other types of comparison would be conceivable.

As a general rule, it would be possible, but not necessary, that the reference depth thresholds associated with the lateral positions are output by the LIDAR measurement device, e.g., provided to the server 109. For instance, one or more such control messages that are indicative of the reference depth thresholds associated with the lateral positions in the field-of-view of the LIDAR measurement device could be output via the communications link. For instance, it would be possible that a corresponding control message is output in response to adjusting the reference depth threshold for a given data point or in response to another trigger (i.e., triggered on-demand). I.e., it would be possible that each time the reference depth threshold is adjusted, a respective control message is output. In some scenarios, a corresponding indicator may also be embedded into the respective point-cloud dataset based on which the reference depth threshold is adjusted.

By outputting the reference depth threshold, it would be possible that LIDAR applications operating based on the LIDAR point-cloud datasets also take into consideration such information of the reference depth thresholds. For example, an object recognition may operate based on such information, e.g., to determine maximum depth extents of foreground objects, considering that the background is static, to give just one example. Thus LIDAR applications can generally operate more accurately based on such additional information.

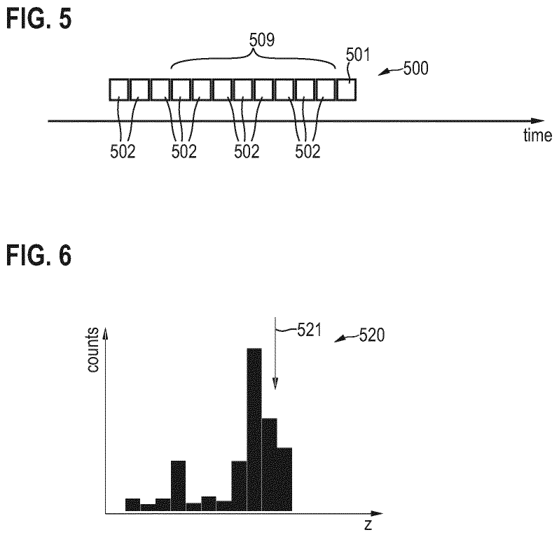

Besides a continuously progressive adjustment of the reference depth threshold as explained, other scenarios are conceivable and one such scenarios explained in connection with FIG. 5 and FIG. 6 below.

FIG. 5 illustrates aspects in connection with the acquisition of point-cloud datasets 501-502. More specifically, FIG. 5 illustrates a time-domain sequence 500 of the acquisition of the point-cloud datasets 501-502. The point-cloud datasets 501-502 are acquired at a given refresh rate, e.g., typically in the order of a few Hz to a few KHz. This is the rate at which the scene 300 is sampled. The currently acquired point-cloud dataset 501 is shown to the right hand side of the sequence 500 and previously acquired (historic) point-cloud datasets 502 are shown to the left. A subset 509 of these previously-acquired point-cloud datasets 502 is used as reference point-cloud datasets and is optionally retained temporarily in the memory of the respective LIDAR measurement device 101-103. It would be possible to select the reference point-cloud datasets from the sequence 500 using a time-domain sliding window that defines the subset 509. I.e., in the illustrated scenarios FIG. 5, the time-domain sliding window includes the eight most recently acquired point-cloud datasets 502; as time progresses, new, more recently acquired point-cloud datasets are added to the subset 509 and the oldest point-cloud datasets are removed, as the time-domain sliding window progresses. This is one example of selecting multiple reference point-cloud datasets. Other examples would be possible, e.g., relying on—possibly manually triggered—calibration phases in which the scene is known to have a well-defined set-up, e.g., not showing foreground objects, etc. In other scenarios, the multiple reference point-cloud datasets could be arranged intermittently, e.g., be selected with inter reference point-cloud dataset time gaps that are longer than the sampling interval is associated with the acquisition of the point-cloud datasets. In any such case, where multiple reference point-cloud datasets are available, it is possible to determine a histogram 520, as illustrated in FIG. 6. The histogram 520 illustrates the distribution of depth positions across the multiple reference point-cloud datasets for a given data point (associated with a certain lateral position within the FOV 602). Then, the maximum value 521 (vertical arrow in FIG. 6) can be determined based on the histogram 520. In particular, statistical fluctuations of the depth position can be taken into account, e.g., by considering an offset from a maximum depth position. A maximum peak value could be determined, based on the histogram 520. A fit of a parametrized function could be used, wherein the parametrized function resembles measurement characteristics of the LIDAR measurement, to thereby determine the maximum value 521.

Next, referring again to FIG. 4, at box 3002, a current point-cloud dataset is received. This can include read-out of a detector and/or analog-digital conversion. Note that in some examples, box 3002 may be executed prior to box 3001, e.g., in scenarios in which the reference depth thresholds for the lateral positions are determined also taking into account the current point-cloud dataset, e.g. a continuously progressive scenarios as explained above.

The method then commences at box 3003. Box 3003 is associated with an iterative loop 3090, toggling through all lateral positions within the field-of-view covered by the point-cloud dataset received at box 3002. Toggling through all lateral positions could be implemented by toggling through all data points included in the point-cloud dataset, wherein different data points are associated with different lateral positions.

At box 3003, it is checked whether there is any non-processed lateral position remaining, taking into account the lateral positions processed at previous iterations 3090. If there is a non-processed lateral position remaining, the method commences at box 3004, at which a currently processed lateral position is selected, from the set of non-processed lateral positions.

A current reference depth threshold is obtained for the currently-selected lateral position. Thus, for different iterations 3090, different reference depth thresholds are obtained at box 3004.

Next, at box 3005, it is checked whether a depth value for the current lateral position selected at box 3004 is available. For instance, scenarios are conceivable in which to point-cloud dataset includes a data point even if the associated LIDAR measurement did not yield any return secondary light, i.e., ranging was not possible (e.g., because a non-reflective low-reflective object is placed at the corresponding lateral position, or because there is no object within the measurement range of the LIDAR measurement device). The data point could then be indicative of the lack of the depth position for the lateral position, e.g., by including a respective indicator (e.g., “−1” or “∞”). However, there are also other scenarios conceivable, e.g., scenarios in which the point-cloud dataset does not include a data point for the corresponding lateral depth position in response to the LIDAR measurement not detecting any return secondary light. Then, the absence of the corresponding data point can be indicative of the depth position not being available for the current lateral position (e.g., there may be define a lateral grid and if for a grid position there is no data point, this can be indicative of the depth position not being available). Hereinafter, such a scenario in which a depth position is not available for the respective lateral position is referred to as a non-defined depth position.

First, the case is discussed in which the depth position is defined, i.e., a depth position is available for the current lateral position. The method then proceeds at box 3008. Here, it is checked whether the current depth position indicates a shorter distance to the LIDAR measurement device if compared to the current reference depth threshold associated with the current lateral position obtained at box 3004. I.e., it can be checked whether the depth position takes a smaller value if compared to the reference depth threshold, at box 3008. If this is the case, then the method commences at box 3010 and the respective data point is maintained at point-cloud dataset. This is because it is plausible that the respective data point corresponds to a foreground object. Otherwise, the method commences at box 3009 and the respective data point is discarded. For example, if the depth position of the data point associated with the current lateral position equals the current reference depth threshold, it can be judged that the scene object is background. Discarding at box 3009 can be implemented by permanently removing a respective entry of the point-cloud dataset.

Now considering the scenario in which, at box 3005, it is judged that a depth position is not available for the current lateral position selected at box 3005, i.e., a non-defined depth position is encountered for the current lateral position. Then, the method commences at box 3006. At box 3006, it is checked whether the current reference depth threshold is finite, i.e., is not set to non-defined, as well. For instance, it would be conceivable that the background of a scene is outside the measurement range of the LIDAR measurement device in which scenario the reference depth threshold could be not undefined/set to infinity.

If both, the depth position as well as the reference depth threshold, are undefined for the current lateral position, then the method commences at box 3009 and, if even available (considering that also the absence of a data point could be used to indicate the non-defined depth position at box 3005), the respective data point is discarded. Otherwise, the method commences at box 3007, and a placeholder data structure is added to the point-cloud dataset. Box 3007 corresponds to a scenario in which a undefined depth position is encountered while a finite reference depth threshold having a defined value is present. Such an absence of return secondary light in the LIDAR measurement can be indicative of a situation in which a low-reflectivity foreground object is present: without the foreground object being present, the background should be detected; then, if the—e.g., black—foreground object is present, this causes zero return secondary light to arrive at the LIDAR measurement device. Such information can be conveyed—e.g., to the server—by adding, to the point-cloud data set, the placeholder data structure that is indicative of the non-defined depth position, at box 3007. Note that, while in the scenario of FIG. 4 the placeholder data structure selectively added to the point-cloud dataset upon the associated reference depth threshold taking a finite value (i.e., the check at box 3006), as a general rule, the check at box 3006 is optional.

In some scenarios, it would be conceivable that the placeholder data structure is indicative of a candidate range of depth position determined based on the reference depth threshold associated with the given lateral position. In particular, a maximum candidate range could be defined by the reference depth threshold, assuming that a foreground object cannot be further away from the LIDAR measurement device than the background and the background, in turn, defining the reference depth threshold. Alternatively or additionally, a minimum candidate range could be set based on performance characteristics of the LIDAR measurement device, e.g., assuming that even low-reflectivity objects located in the proximity of the LIDAR measurement device can be detected. Note that, in some scenarios, indicating such a candidate range can be unnecessary, e.g., if the reference depth thresholds associated with the lateral positions have been already output via the communications link, e.g., as discussed in connection with box 3001. Then, the server 109 can make a respective inference regarding the possible depth positions of the foreground object.

As will be appreciated from the above, branch 3006-3007 of the loop defined by the iterations 3090 makes use of the fact that—when being in possession of a-priori knowledge on the background—even an undefined data point can allow to make an inference of the presence of a foreground object. This helps to implement subsequent LIDAR applications more accurately.

After a number of iterations 3090, at box 3003, it is judged that all lateral positions have been processed. I.e., for all lateral positions, the respective data point has been maintained (box 3010) or discarded (box 3009), or it would even be possible that a placeholder data structure has been added to the point-cloud dataset (box 3007) for the respective lateral position.

Then, the method commences at box 3011 at which the process point-cloud dataset is output, e.g., via the respective interface 1013 to the communications link 108 (cf. FIG. 1 and FIG. 3), so that can be received by the server 109. Since, at least in some scenarios, multiple data points have been discarded at one or more iterations 3090 of box 3010, the process point-cloud dataset that is outputted at box 3011 is size-reduced if compared to the input point-cloud dataset received at box 3002. The discarding of the data point can mean that the respective information is removed from an array structure of the point-cloud dataset, e.g., permanently removed and deleted.

Then, at box 3030, one or more LIDAR applications are executed or triggered. The LIDAR applications operate based on the point-cloud dataset outputted at box 3011.

Box 3030 can, in particular, include multi-pose LIDAR applications that operate based on point-cloud datasets received from multiple LIDAR measurement devices. Box 3030 could be executed by the server 109. One or more backend servers can be involved.

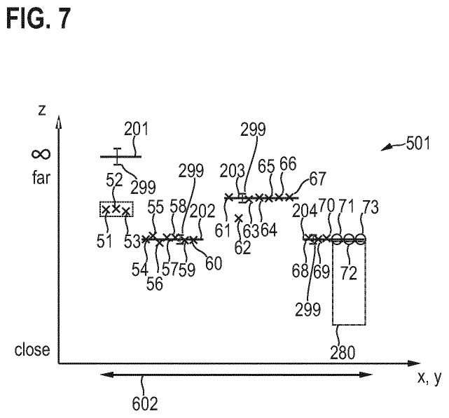

FIG. 7 illustrates aspects with respect to the point-cloud processing of a point cloud 501. In particular, FIG. 7 illustrates aspects with respect to the selective discarding of data points of the point-cloud dataset 501, e.g., as discussed in connection with FIG. 4, box 3009-3010.

FIG. 7 is a 2-D spatial plot illustrating the depth positions (labelled Z-position) and the associated lateral positions (labelled X-position or Y-position). FIG. 7 illustrates the depth position and the lateral position of the data points 51-73 of the point-cloud dataset 501. As illustrated in FIG. 7, the depth position of the data points 51-73 associated with different lateral positions across the FOV 602 varies.

FIG. 7 also illustrates aspects with respect to the reference depth thresholds 201-204. As illustrated in FIG. 7, different lateral positions within the FOV 602 are associated with different reference depth thresholds 201-204 (illustrated by the solid lines in FIG. 7).

Considering the data points 51-53. These data points 51-53 have a depth position that is smaller than the associated reference depth threshold 201 (i.e., they indicate a distance to the LIDAR measurement device 101-104 which is shorter than the distance indicated by the reference depth threshold 201). Accordingly, these data points 51-53 are maintained (cf. FIG. 4: box 3010). This is indicated by the dotted frame in FIG. 7.

Next, on the other hand, the data points 54-60 have depth positions substantially corresponding to the reference depth threshold 202 associated with the respective lateral positions. Accordingly, the data points 54-60 are discarded from the point-cloud dataset 504 (cf. FIG. 4, boxes 3008-3009). “Substantially corresponding” can mean that the difference between the depth positions of the data points 54-60 and the reference depth threshold 202 is smaller than a predefined tolerance 299 (the tolerances 299 are illustrated in FIG. 7 using error brackets with respect to the reference depth threshold 201-204).

As a general rule, the tolerances 299 could be fixed. In other scenarios, the tolerances 299 may depend on the values of the reference depth thresholds 201-204. For example, reference depth thresholds 201-204 further away from the LIDAR measurement device may be associated with higher tolerances 299, because there may be a tendency that the depth position is associated with higher noise for further distances away from the LIDAR measurement device (a corresponding depth jitter is illustrated for the data points 54-60 in FIG. 7). Alternatively or additionally, it would be possible that the tolerances 299 are dynamically determined based on one or more operating conditions of the LIDAR measurement device. I.e., the comparison between the depth values of the data points 51-73 and the reference depth thresholds 201-204 can depend on the one or more operation conditions of the LIDAR measurement device 101-103. Example operating conditions include, but are not limited to: ambient light level, e.g., as detected by a separate ambient light sensor (e.g., for a very bright daylight, higher depth jitter may be expected); operating temperature (e.g., where the operating temperature increases, higher depth jitter may be expected); environmental humidity; etc., to name just a few. I.e., the operating conditions pertain to the interaction of the respective LIDAR measurement device 101-103 and the environment.

By considering such intra-point tolerances 299, the comparison between the depth positions of the data points 51-73 and the reference depth thresholds 201-204 can already take into account the depth jitter to some extent. In some scenarios, it would also be possible to take into account intra-point variations of the depth position of the data points 51-73, in order to even further improve the robustness against depth jitter of the LIDAR measurements. A corresponding scenario is illustrated in FIG. 7 in connection with the data 61-67. Here, as illustrated in FIG. 7, there is a data point 62 that has a depth position that deviates significantly from the associated reference depth threshold 203, i.e., the distance between the depth position of the data point 62 and the associated reference depth threshold 203 is larger than the corresponding tolerance 299. Thus, the comparison yields a substantially different depth position and, in some scenarios, this leads to maintaining the respective data point (cf. FIG. 4: box 3010). However, in some scenarios, it is possible that said selectively discarding of the data points is based on a comparison of the depth position indicated by the given data point (here: data point 62), but also based on one or more further comparisons of the depth position indicated by one or more neighboring data points (here, e.g., nearest neighbor data points 61 and 63). Specifically, for the scenario FIG. 7, this means that the discarding or maintaining of the data point 62 does not only depend on the comparison between the depth position of the data point 62 and the reference depth threshold 203, but also depends on the comparisons of the depth positions of the neighboring data point 61 and 63 with the reference depth threshold 203. Since these comparisons executed for the neighboring data point 61 and 63 yield that the distance between the respective depth positions of the data point 61 and 63 and the reference depth threshold 203 are within the tolerance 299, the data point 62 is considered as an outlier and, accordingly, discarded as well. Such outlier detection based on a joint consideration of multiple comparisons for adjacent lateral positions helps to more accurately discriminate foreground against background. As a general rule, here 2-D nearest neighbors or even next-nearest neighbors could be taken into account.

FIG. 7 also illustrates aspects with respect to a placeholder data structure 280. As previously explained in connection with FIG. 4: block 3007, the placeholder data structure can be used in order to indicate the absence of return secondary light in a scenario in which return secondary light would be expected if the background object was visible (i.e., not obstructed by a foreground object). In the scenario FIG. 7, for lateral positions associated with the data point 68-73, there is a reference depth threshold 204. While the data point 68-70 are defined, i.e., return secondary light is detected, the data points 71-73 are non-defined (as illustrated by the empty circles in FIG. 7; In some scenarios, it would be possible that the point-cloud dataset 501 simply does not include any data points for the lateral positions associated with the data points 71-73 in the scenario FIG. 7). This means that the return secondary light is not detected.

In the scenario, it is possible to add the placeholder data structure 280 to the point-cloud dataset 501, the placeholder data structure 280 in the illustrated example having a minimum and maximum range. The maximum range is limited by the reference depth threshold 204 and/or the minimum range can be limited by device characteristics of the LIDAR measurement device (e.g., minimum detection range or photon count for ultra-low reflectivity objects in the proximity).

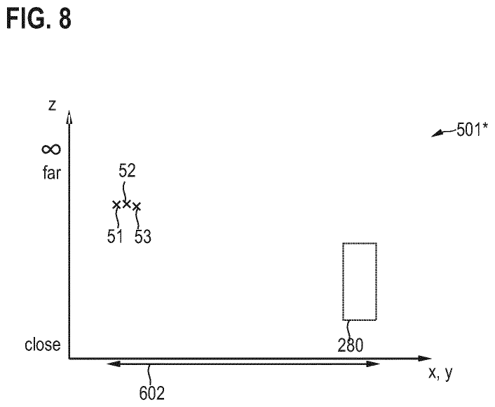

FIG. 8 illustrates the point-cloud dataset 501* upon processing. As illustrated in FIG. 8, the point-cloud dataset 501 only includes the data points 51-53, as well as the placeholder data structure 280. This means that the process point-cloud dataset 501 as illustrated in FIG. 8 sparsely samples the FOV 602 (i.e., only includes information for some of the lateral positions in the FOV 602 for which LIDAR measurements have been carried out), while the non-process point-cloud dataset 501 as illustrated in FIG. is 7 densely samples to FOV 602 (i.e., includes data points or an indication of zero return secondary light) for most or all of the lateral positions within the FOV 602 for which LIDAR measurements have been carried out and for which return secondary light has been detected. Thus, the processed point-cloud dataset 501* is smaller in size and can be processed efficiently.

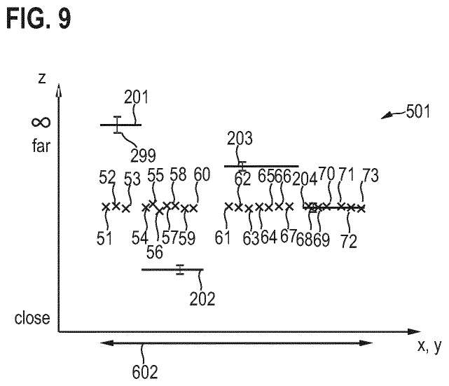

Above, various scenarios have been explained in which, based on the processing of a respective point-cloud dataset, a size reduction of the point-cloud dataset can be achieved, by selectively discarding data points. Alternatively or additionally to such size-reduction techniques, it is also possible to perform processing of the point-cloud datasets in order to detect a fault mode of the LIDAR measurement device. In particular, based on the depth positions of the data points with respect to reference depth thresholds, a judgement on the functional reliability of the LIDAR measurement can be made. Corresponding techniques are illustrated in FIG. 9.

FIG. 9 illustrates aspects with respect to the point-cloud dataset 501. In principle, the point-cloud dataset 501 illustrated in FIG. 9 corresponds to the point-cloud dataset 501 illustrated in FIG. 7. However, in the scenario FIG. 9, the reference depth threshold 202 is defined differently if compared to the reference depth threshold 202 in the scenario FIG. 7. In the scenario FIG. 9, all data points 54-60 have a depth value which is larger than the reference depth threshold 202. These depth positions of the data points 54-60 essentially correspond to the depth positions of the data points 51-53, 61-73

According to various examples, in response to detecting that the comparisons of the predefined count of the data points of the current point-cloud dataset 501 yields that the depth positions indicated by these data points do not substantially equal the respective reference depth thresholds (here: reference depth threshold 201-203), a fault mode of the LIDAR measurement device can be triggered.

This can be based on the finding that, for a fixed-pose LIDAR measurement, it can be expected that the background essentially remains static and that a significant fraction of all data points indicates background objects (i.e., foreground objects are only sparsely encountered). Then, where a significant fraction of all data points has depth positions that deviate from the reference depth thresholds—e.g., more than 40% of all data points or more than 60% of all data points—this could be indicative of a malfunctioning of the LIDAR measurement device and/or of a change of the position of the LIDAR measurement device and/or of obstruction, e.g., dirt on the LIDAR measurement device, etc. In particular, malfunctioning of the LIDAR measurement device can be accurately detected, including multiple units and modules of the LIDAR measurement device along the processing chain, e.g., laser, transmit optics, receive optics, beam steering unit, receiver, time-of-flight ranging analog circuitry, etc. Thus, a high-level functional safety monitoring can be implemented by such comparison between the reference depth thresholds 201-204 and the depth positions indicated by the data points 51-73.

As a general rule, such fault mode detection can be implemented separately from or even without a selectively discarding based on the comparisons.

As a general rule, various implementations are conceivable for the fault mode: For example, a respective fault mode warning message could be output via the communications link 108 to the server 109. Alternatively or additionally, a warning signal may be output via a human machine interface on the LIDAR measurement device 101-103 itself. One or more LIDAR applications operating based on the point-cloud datasets may be aborted or transitioned into a safe state.

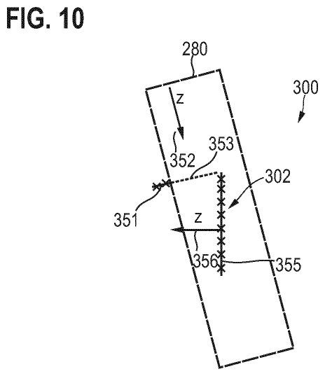

Thus, above techniques with respect to discarding of data points and fault mode detection have been described. As a general rule, various kinds and types of LIDAR applications can benefit from the techniques described herein. As one example, LIDAR application is object detection. Details with respect to an example implementation of the object detection are illustrated in connection with FIG. 10.

FIG. 10 illustrates aspects in connection with a multi-pose LIDAR application in the form of an object detection based on multiple point-cloud datasets obtained from multiple LIDAR measurement devices. For instance, the object detection as illustrated in connection with FIG. 10 could be executed by the server 109, e.g., by the processing circuitry 1091 upon loading program code from the memory 1092. For example, the object detection can be executed at box 3030 (cf. FIG. 4). For this, the server 109 can receive the point-cloud datasets via the communications link 108—e.g., from all LIDAR measurement devices 101-103—and perform the object detection. One or more further point-cloud datasets can be received at the server 109 and then the multi-perspective object detection can be implemented based on all received point-cloud datasets. Data points of a respective aggregated point-cloud data set are illustrated in FIG. 10 (using “x” in FIG. 10).

In the scenario of FIG. 10, point-cloud datasets are received from two LIDAR measurement devices—e.g., the LIDAR measurement device 101 and the LIDAR measurement device 102—that have different perspectives 352, 356 onto the scene 300.

The point-cloud dataset acquired at the perspective 356 includes a set of data points that indicate an edge of a certain foreground object 302 (illustrated by the full line 355 in FIG. 10; right side of FIG. 10).

On the other hand, the LIDAR point-cloud dataset acquired using the perspective 352 only includes a few data points (left side of FIG. 10) close to the respective LIDAR measurement device and the respective edge of the foreground object 302 can be detected, as indicated by the full line 351.

The point-cloud dataset acquired using the perspective 352 also includes a placeholder data structure 280. Based on this placeholder data structure 280, inference can be made that it is likely that the foreground object 302 extends between the full line 351 and the full line 355, as indicated by the dashed line 353. The corresponding surface could be of low-reflectively.

Thus, the object detection can determine a likelihood of presence of the (low-reflectively) foreground object 302 based on the placeholder data structure 280 included in the point-cloud dataset. The corresponding object edge (dashed line 353) of the foreground object 302 can be determined to be within the candidate range of depth positions as indicated by the placeholder data structure 280. More specifically, the hidden edge of the foreground object 302 can be further determined based on the visible edges of the foreground object 302 (full lines 351, 355), e.g., inter-connecting them or being arranged consistently with respect to the visible edges.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various examples have been described with respect to an implementation of the comparison based on a depth position and a respective reference depth position. Alternatively or additionally, it would be possible to consider a reflectivity. This is explained hereinafter. A detector of the LIDAR measurement devices can detect a signal amplitude of the returning secondary light. The signal amplitude of the returning secondary light depends on, e.g., (i) the depth position of the reflective object, (ii) a reflection intensity (reflectivity) of the reflective object, and (iii) a path loss. The influence (i) can be measured using ranging. The influence (iii) can sometimes be assumed to be fixed or can depend on environmental conditions that can be measured, e.g., humidity, etc. Then, based on the signal amplitude, the (ii) reflectivity of the object can be determined. It is then possible to consider the reflectivity of a background object to define a respective reference reflection intensity. Based on a comparison between the measured reflectivity and the reference reflection intensity, it is possible to determine whether a respective data point images the background object or a foreground object. Such comparison of the reflectivity could be combined with the comparison of the depth positions, to make the discrimination between foreground and background more robust.

For further illustration, various examples have been described in the context of a decentralized implementation of the comparisons at the LIDAR measurement devices. It is generally also possible that the techniques described herein are implemented in a centralized fashion. Here, the comparisons are made at a central server.

For still further illustration, various examples have been described in connection with LIDAR-based point clouds. Similar techniques may be implemented for other types of point clouds, e.g., stereocamera-based point clouds, RADAR point clouds, ToF point clouds, etc.

1. A method, comprising:
at a processing circuitry of a LIDAR measurement device, receiving a plurality of data points of a point-cloud dataset, each data point of the plurality of data points of the point-cloud dataset indicating a respective depth position, different data points of the plurality of data points of the point-cloud dataset being associated with different lateral positions in a field-of-view of the LIDAR measurement device, each lateral position being associated with a respective predefined reference depth threshold,
at the processing circuitry of the LIDAR measurement device and for each data point of the plurality of data points of the point-cloud dataset: performing a respective comparison of the depth position indicated by the respective data point with the respective reference depth threshold and selectively discarding the respective data point upon the respective comparison yielding that the depth position indicated by the respective data point substantially equals the respective reference depth threshold, and
at the processing circuitry of the LIDAR measurement device and upon said selectively discarding, outputting, to an external interface of the LIDAR measurement device connected to a communications link, the point-cloud dataset.

2. The method of claim 1,
wherein the point-cloud dataset densely samples the field-of-view prior to said discarding.
wherein the point-cloud dataset sparsely samples the field-of-view after said discarding.

3. The method of claim 1, further comprising:
for each data point of the plurality of data points: determining a maximum value of the depth positions of the respective data point across one or more reference point-cloud datasets and determining the respective reference depth threshold based on this maximum value.

4. The method of claim 1,
wherein the one or more reference point-cloud datasets comprise multiple reference point-cloud datasets
wherein the method further comprises:
for each data point of the plurality of data points: determining a histogram of the depth positions of the respective data point across multiple reference point-cloud datasets and determining the respective reference depth threshold based on the histogram.

5. The method of claim 3,
wherein the one or more reference point-cloud datasets comprise multiple reference point-cloud datasets,
wherein a sequence of point-cloud datasets comprising the point-cloud dataset is acquired by the LIDAR measurement device,
wherein the method further comprises:
selecting the multiple reference point-cloud datasets from the sequence of point-cloud datasets using a time-domain sliding window.

6. The method of claim 1,
wherein said selectively discarding of a given data point of the plurality of data points based on the respective comparison of the depth position indicated by the given data point and one or more further comparisons of the depth positions indicated by one or more further data points of the plurality of data points being associated with lateral positions neighboring the lateral position associated with the given data point.

7. The method of claim 1, further comprising:
in response to detecting that the respective comparisons of a predefined count of the data points of the plurality of data points yield that the depth positions indicated by these data points do not substantially equal the respective reference depth threshold triggering a fault mode of the LIDAR measurement device

8. The method of claim 1, further comprising:
at the processing circuitry of the LIDAR measurement device: detecting that the point-cloud dataset indicates a non-defined depth position for a given lateral position for which a finite respective reference depth threshold is predefined,
adding, to the point-cloud dataset, a placeholder data structure indicative of the non-defined depth position

9. The method of claim 8.
wherein the placeholder data structure is indicative of a candidate range of depth positions determined based on the reference depth threshold associated with the given lateral position.

10. The method of claim
wherein the placeholder data structure is selectively added to the point-cloud dataset upon the associated reference depth threshold

11. The method of claim 1, further comprising:
receiving the point-cloud dataset at a server from the LIDAR measurement device and via the communications link, and
performing an object detection at the server based on the point-cloud dataset

12. The method of claim 11, further comprising:
receiving one or more further point-cloud datasets at the server from one or more further LIDAR measurement devices,
wherein the object detection is a multi-perspective object detection based on the point-cloud dataset the one or more further point-cloud datasets.

13. The method of claim 8,
wherein the object detection determines a likelihood of presence of a low-reflectivity object based on the placeholder data structure included in the point-cloud dataset.

14. The method of claim 13,
wherein the placeholder data structure is indicative of a candidate range of depth positions determined based on the reference depth threshold associated with the given lateral position, and
wherein the object detection determines an object edge of an object to be within the candidate range of depth positions and based on at least one further object edge detected in the one or more further second point-cloud data sets.

15. The method of claim 1, further comprising:
outputting, to the external interface of the LIDAR measurement device connected to the communications link, one or more control messages indicative of the reference depth thresholds associated with the lateral positions in the field-of-view of the LIDAR measurement device.

16. The method of claim 1,
wherein the comparison takes into account a tolerance,
wherein the tolerance depends on one or more current operation conditions of the LIDAR measurement device.

17. A processing circuitry of a LIDAR measurement device, configured to:
receive a plurality of data points of a point-cloud dataset, each data point of the plurality of data points of the point-cloud dataset indicating a respective depth position, different data points of the plurality of data points of the point-cloud dataset being associated with different lateral positions in a field-of-view of the LIDAR measurement device, each lateral position being associated with a respective predefined reference depth threshold,
for each data point of the plurality of data points of the point-cloud dataset: perform a respective comparison of the depth position indicated by the respective data point with the respective reference depth threshold and selectively discard the respective data point upon the respective comparison yielding that the depth position indicated by the respective data point substantially equals the respective reference depth threshold, and
upon said selectively discarding, output, to an external interface of the LIDAR measurement device connected to a communications link, the point-cloud dataset.

18. The processing circuitry of claim 17,
wherein the processing circuitry is configured to perform a method comprising:
at the processing circuitry of the LIDAR measurement device, receiving a plurality of data points of a point cloud dataset, each data point of the plurality of data points of the point cloud dataset indicating a respective depth position, different data points of the plurality of data points of the point cloud dataset being associated with different lateral positions in a field-of-view of the LIDAR measurement device, each lateral position being associated with a respective predefined reference depth threshold,
at the processing circuitry of the LIDAR measurement device and for each data point of the plurality of data points of the point cloud dataset: performing a respective comparison of the depth position indicated by the respective data point with the respective reference depth threshold and selectively discarding the reactive data point upon the respective comparison yielding that the depth position Indicated by the respective data point substantially equals the respective reference depth threshold, and
at the processing circuitry of the LIDAR measurement device and upon said selectively discarding, outputting, to an external interface of the LIDAR measurement device connected to a communications link, the point-cloud dataset.

19. A method, comprising:
at a processing circuitry of a LIDAR measurement device, receiving a plurality of data points of a point-cloud dataset, each data point of the plurality of data points of the point-cloud dataset indicating a respective depth position and a respective reflection intensity, different data points of the plurality of data points of the point-cloud dataset being associated with different lateral positions in a field-of-view of the LIDAR measurement device, each lateral position being associated with at least one of a respective predefined reference depth threshold or a respective predefined reference reflection intensity,
at the processing circuitry of the LIDAR measurement device and for each data point of the plurality of data points of the point-cloud dataset: performing a respective comparison of at least one of the depth position or the reflection intensity indicated by the respective data point with the at least one of the respective reference depth threshold or the respective reference reflection intensity and selectively discarding the respective data point upon the respective comparison yielding that the at least one of the depth position or the reflection intensity indicated by the respective data point substantially equals the at least one of the respective reference depth threshold or the respective reference reflection intensity, and
at the processing circuitry of the LIDAR measurement device and upon said selectively discarding, outputting, to an external interface of the LIDAR measurement device connected to a communications link, the point-cloud dataset.
